(19) United States
(12) Patent Application Publication
(10) Pub. No.: US 2002/0126864 A1
(43) Pub. Date: Sep. 12, 2002

(54) Hearing devices kit

(76) Inventors: George J. Dennis III, Park City, UT (US); Vincent A. Primerano, Las Vegas, NV (US)

Correspondence Address: G. DONALD WEBER, JR., 18442 Taft Avenue, Villa Park, CA, 92861, US

(21) Appl. No.: 09/799,657

(22) Filed: Mar. 7, 2001

(51) Int. Cl. H04R 25/00

(52) U.S. Cl. 381/322; 381/328

(57) ABSTRACT

A kit for a hearing assistance system which includes a hearing aid appliance, at least one of an assistive listening device for a specific sound source, a plurality of hearing aid appliance, maintenance and diagnostic accessories and a compact storage container therefor. The container, typically, includes a plurality of storage locations and information on hearing related topics and a hinged cover for retaining the various components therein. At least one of the storage locations includes a component retaining mechanism therein.

### BACKGROUND

1. Field of the Invention

This invention is directed to a kit for hearing assistance devices, in general, and to such a kit which provides easy, ready access to a plurality of hearing assistance devices and maintenance and diagnostic accessories, in particular.

2. Prior Art

There are many known hearing assistance devices available in today's market for those individuals who have hearing impairments and/or live in environments which interfere with normal hearing.

Hearing assistance devices range from hearing aid appliances to assistive listening devices (ALD). Typically, hearing aid appliances (durable or disposable) are inserted into (or mounted adjacent to) the user's ear. Likewise, ALD's typically comprise signaling devices such as light activators, as well as hearing enhancement sources such as television listening devices and telephone amplifiers which isolate desirable sound from background sound and ambient noises.

In the past, the devices, appliances and accessories have been marketed or distributed substantially individually. That is, in a typical scenario, an individual undergoes a hearing test or the like to determine his/her needs for a hearing aid appliance to enhance hearing capability. The hearing aid appliance is purchased, typically, from the hearing test establishment, which is typically an audiologist, ear, nose and throat doctor or a licensed hearing aid dispenser.

After the hearing aid appliance has been obtained, the individual must then shop for any add-ons, supplemental units or the like often referred to as ALD's and accessories. These additional components are most frequently not marketed or readily available in a single location. As a result, the individual must make several time consuming trips to several different sources in order to assemble a complete hearing assistance system. Of course, acquisition of these add-ons may not occur because it is known that most individuals are unaware that these add-ons and supplemental components even exist.

Thus, there exists a need to provide a complete and comprehensive hearing assistance system which is available at a single location in a single package arrangement.

In addition, hearing professionals have recently published articles which argue and demonstrate that the success rates for individuals who purchase hearing aids increases when accompanied by a select number of assistive listening devices

### SUMMARY OF THE INSTANT INVENTION

A kit for a hearing assistance system which includes a hearing aid appliance, at least one of an assistive listening device (ALD) for a specific sound source, hearing signaling devices, maintenance and diagnostic accessories used with the other components and a compact storage container therefor. The container, typically, includes a plurality of storage locations and a hinged cover for retaining the various components therein.

### BRIEF DESCRIPTION OF THE DRAWINGS

FIG. 1 is an oblique view of one embodiment of the kit container of the instant invention in the closed position.

FIG. 2 is an oblique view of the kit container in FIG. 1 in the open position.

FIG. 3 is a plan view of the kit container shown in FIG. 2 with several representative components included therein.

FIG. 4 is an oblique view of another embodiment of the kit container in the closed position.

FIG. 5 is an oblique view of the kit container in FIG. 4 in the open position.

FIG. 6 is a plan view of the kit container shown in FIG. 5 with several representative components included therein.

FIG. 7 is an end view of the kit container shown in FIG. 4 in the partially open position.

### DESCRIPTION OF A PREFERRED EMBODIMENT

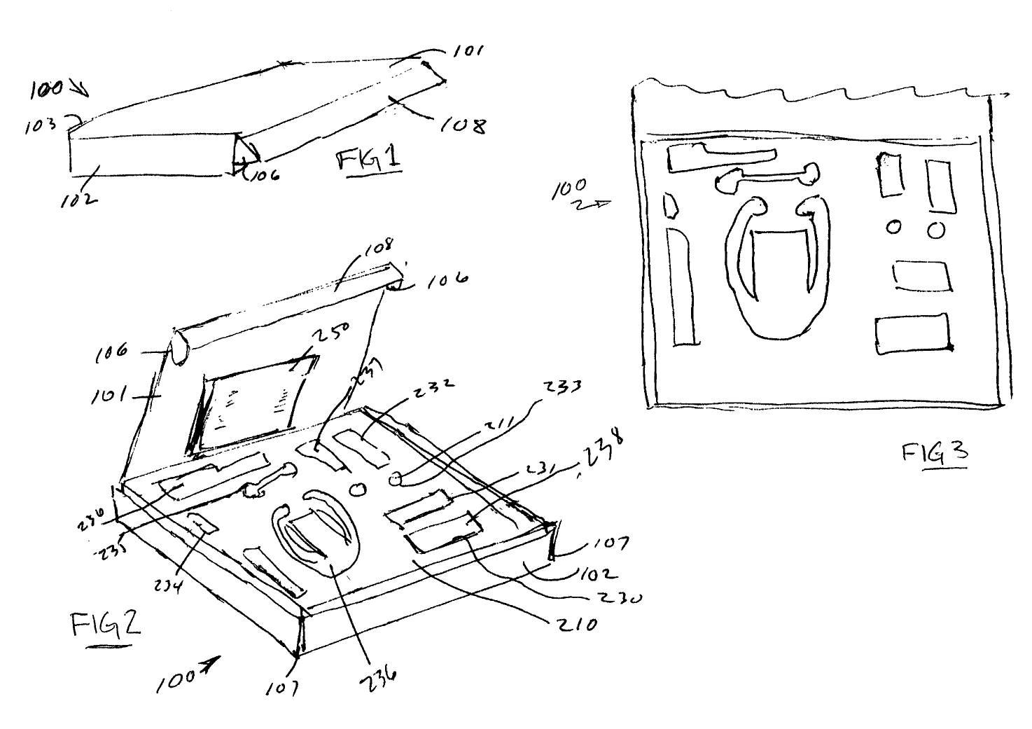

Referring now to FIG. 1, there is shown an oblique view of a preferred embodiment of the kit container 100 of the instant invention. Typically, the container 100 comprises the upper section or lid 101 and a main storage section 102 is referred to as the lower (or right) section. These designations are for convenience of discussion and are not, in any way, limitative of the invention.

The lid 101 and storage section 102 are each joined at a spine 103 (which can be an integral hinge) or by separate hinges (not shown). This arrangement permits the lid and storage sections 101 and 102 to provide a convenient package for the kit components.

A suitable closure tab 106 can be provided at one end or both sides of the lid end flap 108 of lid 101, as desired, to assure that the kit container 100 does not open inadvertently and disgorge the contents thereof. The closure tab 106 can be of any conventional configuration and is adapted to be inserted into a slot 107 at the side of the storage section 102.

Referring concurrently now to FIGS. 2 and 3, there is shown an oblique and a plan view, respectively, of the kit container 100 in the open condition. The lid and storage section 101 and 102, respectively, are joined together by the hinge 103. The hinge can take any suitable form such as ring hinges, spiral hinges or the like. Typically, in this embodiment, the hinge 103 is formed integrally as part of storage section 102 and the lid 101 which are, thus, joined together.

Interior walls can be provided in any suitable or desired arrangement to store the components described elsewhere. In this embodiment, the interior walls are provided in a suitable foam insert 300 or the like. As shown, the inset 210 includes a plurality of receptacles, 230, 231, 232, 233, 234 and so forth or boxes of various shapes and sizes formed therein. The receptacles can be positioned and shaped as desired in order to provide boxes of any suitable shapes and/or sizes.

In the preferred embodiment, a number of retaining devices 22, such as plugs formed of the same type of foam can be provided in one or more of the boxes or cubicles, e.g. receptacle 133. The retaining devices can take the shape of the receptacle and establish a tight, friction fit therewith to establish a pocket or any other suitable retaining device. The retaining devices 21 1, for example, are adapted to receive and retain a component within the respective cubicle.

The components which can be retained within the respective cubicles can be any one or more of items. Hearing aids can be stored in a protective container in receptacle 237 while a cleaning kit can be stored in receptacle 238. For example, batteries can be stored in receptacle 231 and a battery tester on a key chain can be stored in receptacle 235. Cerumen guards, telephone comfort pads and other devices can be placed as desired. Instruction manuals 250 are, typically, stored loosely in the storage section 102.

Other components which can be retained within other cubicles are a television listening system, such as TV EARS stored in receptacle 236. An AC adapter can be stored in receptacle 236. In addition, ear tips, ear molds, transmitter, chargers, audio cords, audio accessory adapters or headset are other components which are, typically, stored in the cubicles in section 102.

Clearly, the embodiment described supra has a significant advantage over any product known in the art. This kit container, and the contents thereof, permit the marketing of hearing aids and related hearing assistance devices. The conventional and/or professional dispenser of the hearing aids and related components has a convenient kit available for introduction and, possibly, sale to a hearing aid customer/user.

Conversely, the hearing aid user has available a kit of hearing aid related devices without the necessity for visiting multiple establishments—which may not carry compatible goods. In addition, the user has a convenient apparatus for storing the hearing assistance components in a single compact storage device.

The kit container 100 can be fabricated of any suitable material which is preferably lightweight, yet strong and durable. The container can be fabricated of cardboard, for example, or it can be fabricated of plastic such as by blow molding or the like.

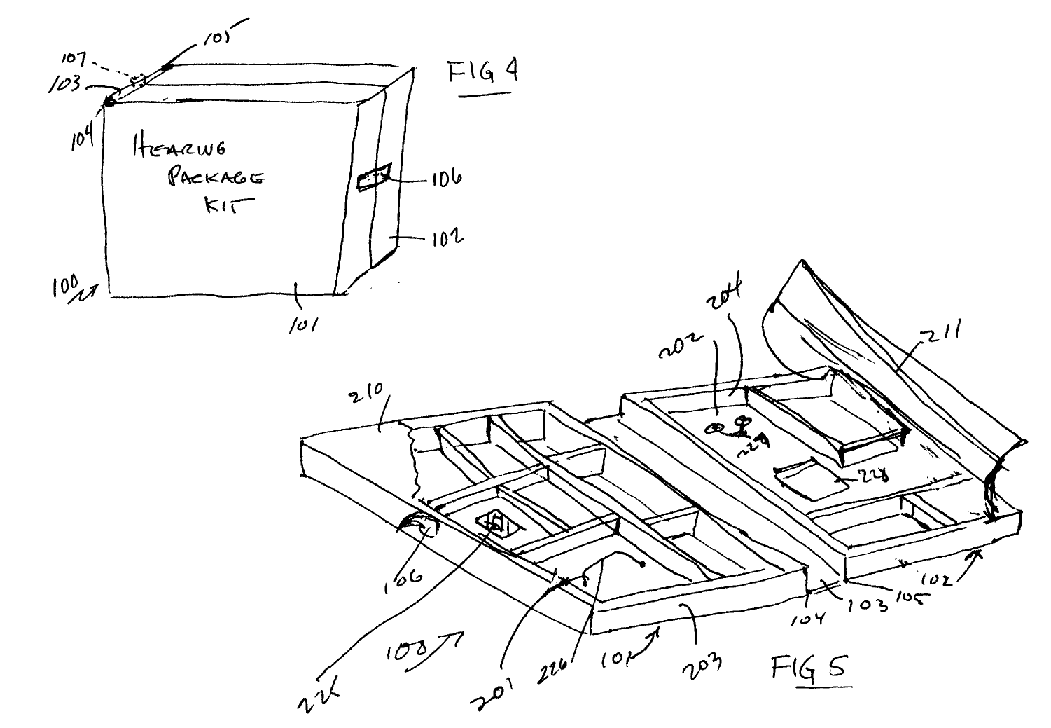

Referring now to FIG. 4, there is shown an oblique view of a second embodiment of the kit container 400 of the instant invention. Typically, the container 400 comprises at least two compatible sections 401 and 402. In the second embodiment, the section 401 is referred to as the upper (or left) section and section 402 is referred to as the lower (or right) section. These designations are for convenience of discussion and are not, in any way, limitative of the invention.

The sections 401 and 402 are each joined to a spine 403 by respective hinges 404 and 405 This arrangement permits the sections 401 and 402 to be of different depths and yet provide a convenient package for the kit components. A single hinge 407 (shown in dashed outline) can be utilized between the two sections—as shown—if both sections are of equal depth or in lieu of hinge 404 or 105 if an uneven opened container is acceptable.

Suitable closure means 106 can be provided, if desired, to assure that the kit container 400 does not open inadvertently and disgorge the contents thereof. The closure 406 can be a conventional strap, a snap, a Velcro fastener or the like.

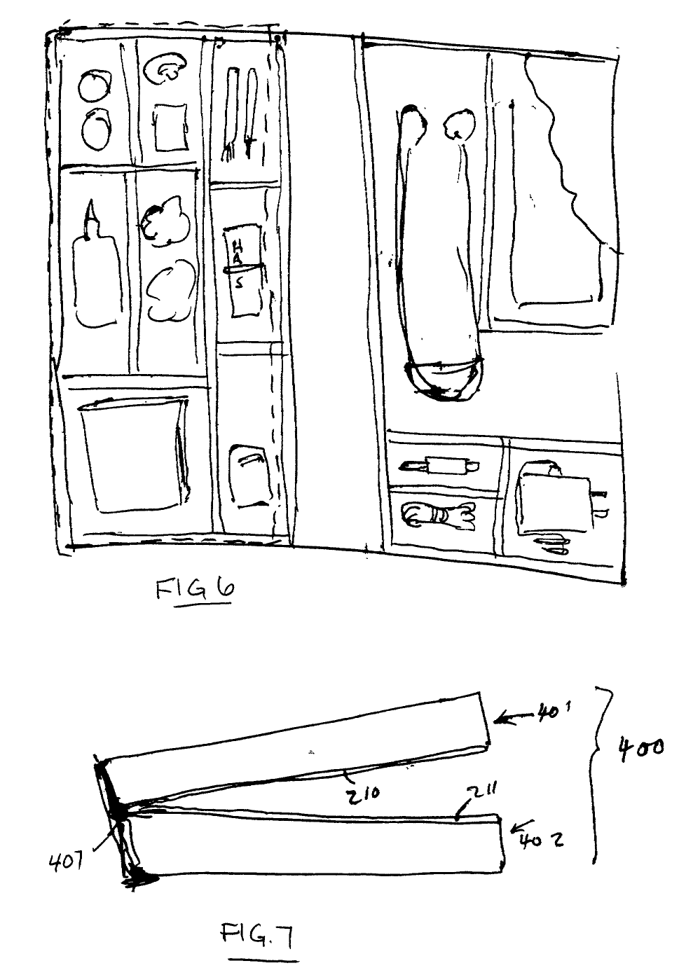

Referring concurrently now to FIGS. 5 and 6, there is shown an oblique and a plan view, respectively, of the kit container 400 in the open condition. The sections 401 and 402 are joined to the hinges 404 and 405, respectively. The hinges can take any suitable form such as ring hinges, spiral hinges or the like. They can be formed integrally as part of an outer layer which is joined to the spline 103 and the outer surfaces of sections 404 and 405.

As suggested supra, the compound hinges can be replaced by a single hinge (not shown) which is joined to the upper edges of the rear surfaces of the sections 404 and 405, if so desired.

In this embodiment, the sections 401 and 402 include primary layers 501 and 502 which serve as the outer walls of the container. The outer surfaces of layer 501 is visible best in FIG. 4. The inner surfaces of layers 501 and 502 are both visible in FIG. 6. The layers 501 and 502 support an outer perimeter wall 503 and 504, respectively. The perimeter walls also serve as the sides and edges of the kit container 400.

A plurality of interior walls 505 and 506, for example, are affixed to or integral with the layers 501 and 502, respectively. The interior walls can be provided in any suitable or desired arrangement to store the components described elsewhere. As shown, the interior walls form a plurality of rectilinear boxes of various shapes and sizes. The walls can be positioned as desired in order to provide boxes of other shapes and/or sizes.

In the preferred embodiment, a number of retaining devices can be provided in one or more of the boxes or cubicles. The retaining devices can take the form of a Velcro strip 525; an elastic band 526; snap receptors 527; an envelope or pocket 528 or any other suitable retaining device. The retaining devices 525-528 are adapted to receive and retain a component within the respective cubicle.

The components which can be retained within the respective cubicles can be any one or more of items such as batteries, hearing aids, cerumen guards, telephone comfort pads, battery testers, instruction manuals which are, typically, stored in the cubicles in section 401.

Other components which can be retained within other cubicles are a television listening system, such as TV EARS, ear tips, ear molds, transmitter, chargers, audio cord, AC adapter, audio accessory adapter, headset. These components are, typically, stored in the cubicles in section 402.

Also shown are document storage folders 510 and 511 which are attached to the edges of sections 401 and 402, respectively. Typically, the storage folders are formed of a soft, pliant material such as plastic. The plastic can be transparent for convenient access to any document stored therein. In a preferred embodiment, the storage folders can be adhered to the upper surface of an end wall of the respective section by, for example, glue. Of course, the folders are not an essential portion of the invention.

Clearly, the embodiment described supra has a significant advantage over any product known in the art. This kit container, and the contents thereof, permit the marketing of hearing aids and related hearing assistance devices. The conventional and/or professional dispenser of the hearing aids and related components has a convenient kit available for introduction and, possibly, sale to a hearing aid customer/user.

Conversely, the hearing aid user has available a kit of hearing aid related devices without the necessity for visiting multiple establishments—which may not carry compatible goods. In addition, the user has a convenient apparatus for storing the hearing assistance components in a single compact storage device.

The kit container 400 can be fabricated of any suitable material which is preferably lightweight, yet strong and durable. The container can be fabricated of cardboard, for example, or it can be fabricated of plastic such as by blow molding or the like.

Referring now to FIG. 7, there is shown an elevation, end view of the kit container 700 shown partly ajar. The container comprises the upper and lower sections 701 and 702, respectively. In this embodiment, the sections are joined together by a single, common hinge 707 which replaces the spine and dual hinges in the embodiments depicted in FIGS. 4-6. The optional jackets or folios 510 and 511 are depicted in this embodiment as well. From this embodiment, it is clear that modifications in the specific structural details of the kit container can be varied without departing from the spirit of the invention.

Thus, there is shown and described a unique concept of a hearing aid devices kit and the design of relevant container for the kit. While this description is directed to preferred embodiments, it is understood that those skilled in the art may conceive modifications and/or variations to the specific embodiments shown and described herein. Any such modifications or variations which fall within the purview of this description are intended to be included therein as well. It is understood that the description herein is intended to be illustrative only and is not intended to be limitative. Rather, the scope of the invention described herein is limited only by the claims appended hereto.

1. A kit for hearing devices comprising,
at least one assistive listening device,
at least one hearing aid device, and
a common container for retaining each said assistive listening device and each said hearing aid device.

2. The kit recited in claim 1 including,
at least one hearing aid device accessory retained within said container.

3. The kit recited in claim 1 wherein,
said assistive listening device comprises a wireless system adapted for transmitting audio signals from a television device.

4. The kit recited in claim 1 wherein,
said hearing aid device is designed for insertion into an ear of the user.

5. The kit recited in claim 2 wherein,
said accessory includes hearing aid batteries.

6. The kit recited in claim 1 including,
at last one maintenance accessory.

7. The kit recited in claim 1 including,
at least one diagnostic accessory.

8. The kit recited in claim 6 wherein,
said maintenance accessory includes cerumen guards.

9. The kit recited in claim 7 wherein,
said diagnostic accessory comprises a battery tester.

10. The kit recited in claim 6 wherein,
said maintenance accessory includes a cleaning pick and brush.
